(19) United States
(12) Patent Application Publication
(10) Pub. No.: US 2025/0187391 A1
(43) Pub. Date: Jun. 12, 2025

(54) VEHICLE

(71) Applicant: HONDA MOTOR CO., LTD., Tokyo (JP)

(72) Inventors: Yoshiyuki TAKEUCHI, Tokyo (JP); Keiji TOJO, Tokyo (JP); Akira INOUE, Tokyo (JP)

(73) Assignee: HONDA MOTOR CO., LTD., Tokyo (JP)

(21) Appl. No.: 18/968,450

(22) Filed: Dec. 4, 2024

(30) Foreign Application Priority Data
Dec. 6, 2023 (JP) 2023-206028

(51) Int. Cl. B60H 1/00; B60H 1/14; B60H 1/32; B60K 11/04; H01M 10/613; H01M 10/625; H01M 10/6551; H01M 10/6569; H01M 10/663

(52) U.S. Cl. CPC B60H 1/00278; B60H 1/143; B60H 1/32284; B60K 11/04; H01M 10/613; H01M 10/625; H01M 10/6551; H01M 10/6569; H01M 10/663; B60H 2001/00307; H01M 2220/20

(57) ABSTRACT

A vehicle, including: a battery; a battery cooling circuit configured to allow a first coolant to flow and adjust a temperature of the battery; a refrigeration cycle for air conditioning including an electric compressor, a condenser, an outdoor heat exchanger, and an evaporator, and configured to allow a second coolant to flow; and a heating circuit including a heater core and configured to allow a third coolant to flow, in which the battery cooling circuit, the refrigeration cycle, and the heating circuit are configured to allow the first coolant, the second coolant, and the third coolant flow through respective circuits independently, and the condenser is configured to exchange heat between the second coolant flowing through the refrigeration cycle and the third coolant flowing through the heating circuit.

### CROSS-REFERENCE TO RELATED APPLICATIONS

This application is based on and claims priority under 35 USC 119 from Japanese Patent Application No. 2023-206028 filed on Dec. 6, 2023, the entire content of which is incorporated herein by reference.

### TECHNICAL FIELD

The present invention relates to a vehicle including a battery.

### BACKGROUND ART

In recent years, efforts to realize a low-carbon society or a decarbonized society become active, and research and development about an electrification technique are conducted to reduce CO₂ emission and improve energy efficiency in vehicles.

In an electric vehicle including a battery, it is impossible to heat a passenger compartment using waste heat of an engine as in an internal combustion engine (ICE) vehicle in the related art, and thus an electric heater is provided in a circuit for air conditioning provided with a heater core.

As a thermal management system for such an electric vehicle, U.S. Ser. No. 11/390,135B discloses a circuit in which a battery cooling circuit and a circuit for air conditioning provided with a heater core are connected.

In the circuit of U.S. Ser. No. 11/390,135B, the battery cooling circuit and the circuit for air conditioning provided with the heater core are connected, and thus there is a possibility that an operation status of the battery may affect a marketability of heating and cooling in the passenger compartment. Typically, a heating, ventilation and air conditioning (HVAC) system is installed in a dashboard of a vehicle as an air conditioning circuit, but if the battery cooling circuit and the circuit for air conditioning provided with the heater core are connected, there is a possibility that changing from the HVAC of the ICE vehicle is complicated and a cost increases.

An object of the present invention is to provide a vehicle that can cool and heat an interior of a passenger compartment without being affected by a battery cooling circuit, and can reduce a manufacturing cost.

### SUMMARY OF INVENTION

According to an aspect of the present invention, there is provided a vehicle, including:
a battery;
a battery cooling circuit configured to allow a first coolant to flow and adjust a temperature of the battery;
a refrigeration cycle for air conditioning including an electric compressor, a condenser, an outdoor heat exchanger, and an evaporator, and configured to allow a second coolant to flow; and
a heating circuit including a heater core and configured to allow a third coolant to flow, in which
the battery cooling circuit, the refrigeration cycle, and the heating circuit are configured to allow the first coolant, the second coolant, and the third coolant flow through respective circuits independently, and
the condenser is configured to exchange heat between the second coolant flowing through the refrigeration cycle and the third coolant flowing through the heating circuit.

### BRIEF DESCRIPTION OF DRAWINGS

FIG. 1 is a circuit diagram illustrating a configuration of a coolant circuit 1 provided in a vehicle V;

FIG. 2 is an illustration diagram showing a flow of a coolant according to switching states of a first switching valve 52 (shut-off state) and a second switching valve 54 (non-bypass state) in the coolant circuit 1 of FIG. 1;

FIG. 3 is an illustration diagram showing a flow of the coolant according to the switching states of the first switching valve 52 (communication state) and the second switching valve 54 (bypass state) in the coolant circuit 1 of FIG. 1;

FIG. 4 is an illustration diagram showing a flow of the coolant in a first passenger compartment heating mode in the coolant circuit 1 of FIG. 1;

FIG. 5 is an illustration diagram showing a flow of the coolant in a second passenger compartment heating mode in the coolant circuit 1 of FIG. 1;

FIG. 6 is an illustration diagram showing a flow of the coolant in a third passenger compartment heating mode in the coolant circuit 1 of FIG. 1;

FIG. 7 is a schematic configuration diagram of the vehicle V.

### DESCRIPTION OF EMBODIMENTS

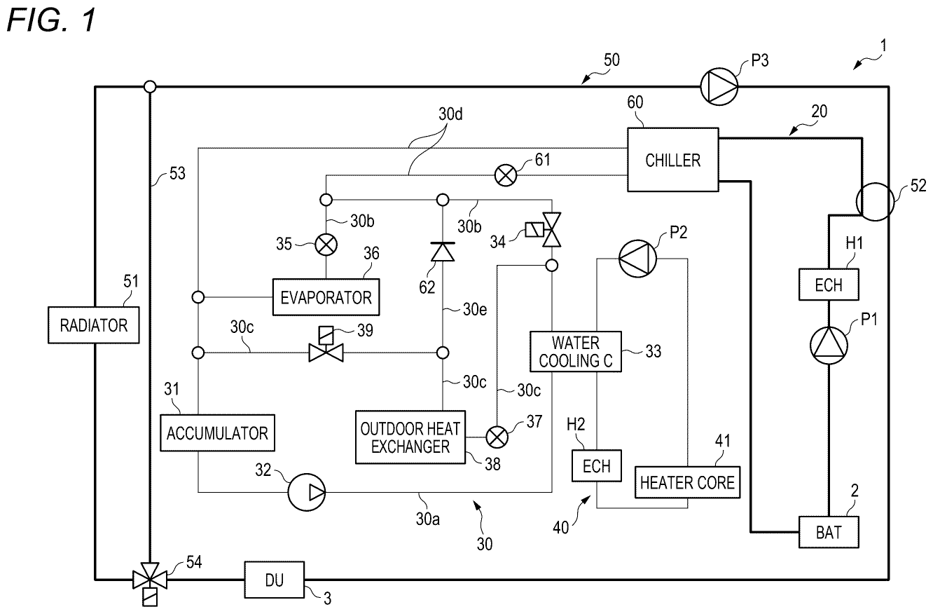

Hereinafter, an embodiment of the present invention will be described with reference to FIGS. 1 to 7.

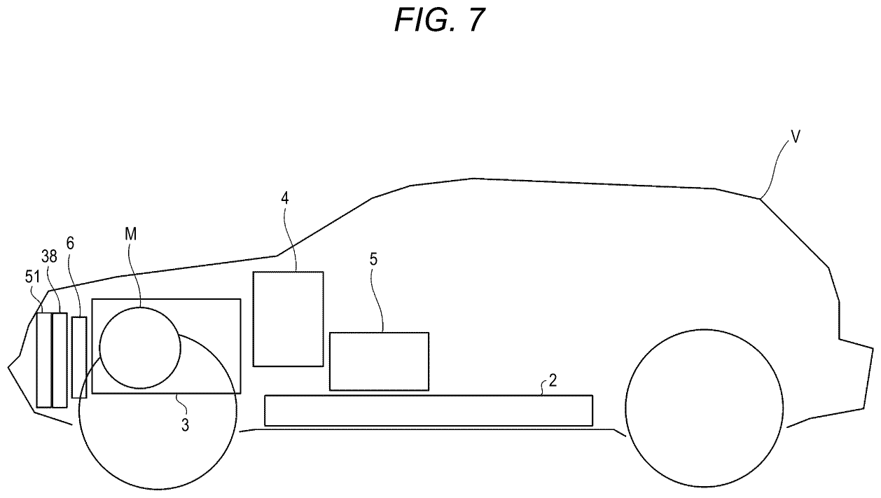

As shown in FIG. 7, a vehicle V is an electric vehicle including a battery 2, a drive device 3 that drives the vehicle V to travel by electric power supplied from the battery 2, an HVAC 4 that controls air conditioning in a passenger compartment, and a control device 5. The drive device 3 includes a heat source such as a motor M, an inverter, a DC-DC converter, and a charger. The HVAC 4 includes an evaporator 36 of a refrigeration cycle 30 (described later) and a heater core 41 of a heating circuit 40 (described later). A radiator 51 of a drive device cooling circuit 50 (described later), an outdoor heat exchanger 38 of the refrigeration cycle 30, and an electric fan 6 for promoting heat radiation and/or heat absorption of the radiator 51 and the outdoor heat exchanger 38 are provided at a front side of the vehicle V.

A coolant circuit 1 shown in FIG. 1 is mounted on the vehicle V. The coolant circuit 1 includes a battery cooling circuit 20, the refrigeration cycle 30, the heating circuit 40, the drive device cooling circuit 50, and a chiller 60.

In the battery cooling circuit 20, the first coolant flows, and a temperature of the battery 2 (BAT) is adjusted. The battery cooling circuit 20 includes the battery 2, a first pump P1 that circulates a first coolant in the battery cooling circuit 20, and a first electric heater H1 (ECH) that can heat the first coolant. The first coolant is, for example, a long life coolant (LLC).

In the refrigeration cycle 30, a second coolant flows, and air-conditioning of the passenger compartment is performed. The refrigeration cycle 30 includes a shared flow path 30a shared during cooling and heating, a flow path for cooling 30b used during cooling, a flow path for heating 30c used during heating, and a connection flow path 30e connecting the flow path for cooling 30b and the flow path for heating 30c. The second coolant is, for example, an air conditioner coolant.

The shared flow path 30a includes an accumulator 31 that separates the vaporized second coolant and the liquid second coolant, an electric compressor 32 that compresses the vaporized second coolant, and a condenser 33 (water cooling C) that absorbs heat from the compressed second coolant having a high pressure and a high temperature and liquefies the second coolant. Since the condenser 33 is provided at a downstream side of the electric compressor 32 in a flow direction of the second coolant, heat of the compressed second coolant having a high pressure and a high temperature can be supplied to the heating circuit 40 via the condenser 33.

The flow path for cooling 30b includes a high pressure solenoid valve 34 that switches between the flow path for cooling 30b and the flow path for heating 30c at a downstream side of the condenser 33, an expansion valve for cooling 35 that vaporizes the second coolant, and an evaporator 36 that absorbs heat from air in the passenger compartment by the second coolant having a low pressure and a low temperature.

The flow path for heating 30c includes an expansion valve for heating 37 that can vaporize the second coolant at the downstream side of the condenser 33, the outdoor heat exchanger 38 that absorbs heat from outside air by the second coolant having a low pressure and a low temperature and radiates heat to the outside air by the second coolant having a high temperature and a high pressure, and a low pressure solenoid valve 39 that switches between the flow path for cooling 30b and the flow path for heating 30c.

The connection flow path 30e is disposed to connect the outdoor heat exchanger 38 and the low pressure solenoid valve 39 of the flow path for heating 30c, and to connect the high pressure solenoid valve 34 and the expansion valve for cooling 35 of the flow path for cooling 30b, and is provided with a check valve 62 in the middle.

In the heating circuit 40, the third coolant flows, and the passenger compartment is heated. The heating circuit 40 includes a second pump P2 that circulates a third coolant in the heating circuit 40, a second electric heater H2 (ECH) that can heat the third coolant, and a heater core 41 that heats the passenger compartment by heat exchange with the third coolant. The third coolant is, for example, LLC.

The third coolant and the first coolant may be the same type of coolant, but the first coolant, the second coolant, and the third coolant flow independently and do not mix with each other. Therefore, the battery cooling circuit 20 can be independent of the refrigeration cycle 30 and the heating circuit 40, and thus it is possible to continue to use an HVAC of an engine vehicle at a low cost.

The heating circuit 40 passes through the inside of the condenser 33 at a downstream side of the second pump P2. The condenser 33 is configured to exchange heat between the second coolant circulating in the refrigeration cycle 30 and the third coolant circulating in the heating circuit 40.

In the drive device cooling circuit 50, the first coolant flows, and the drive device 3 (DU) is cooled. The drive device cooling circuit 50 includes a third pump P3 that circulates the first coolant in the drive device cooling circuit 50, the drive device 3, and the radiator 51 that cools the first coolant.

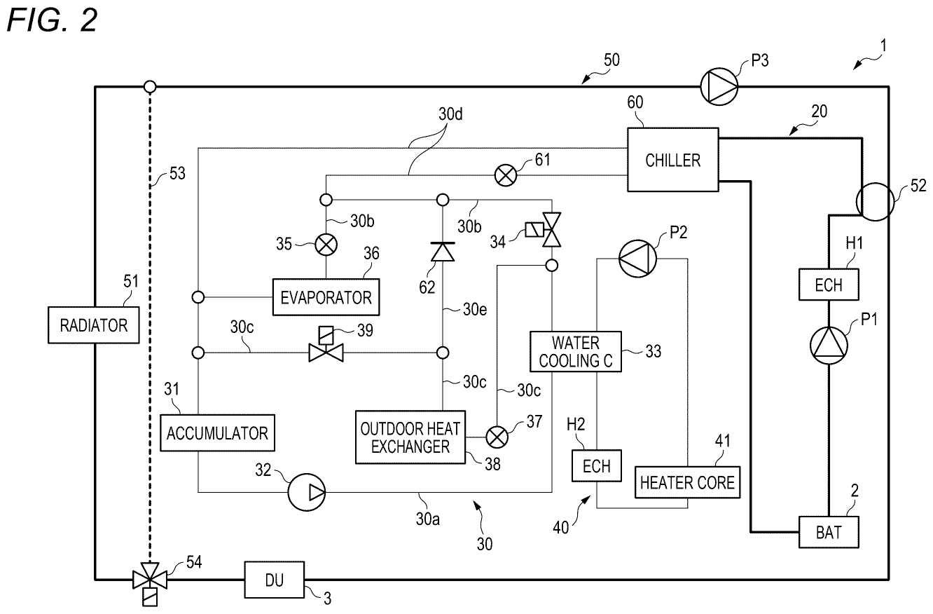

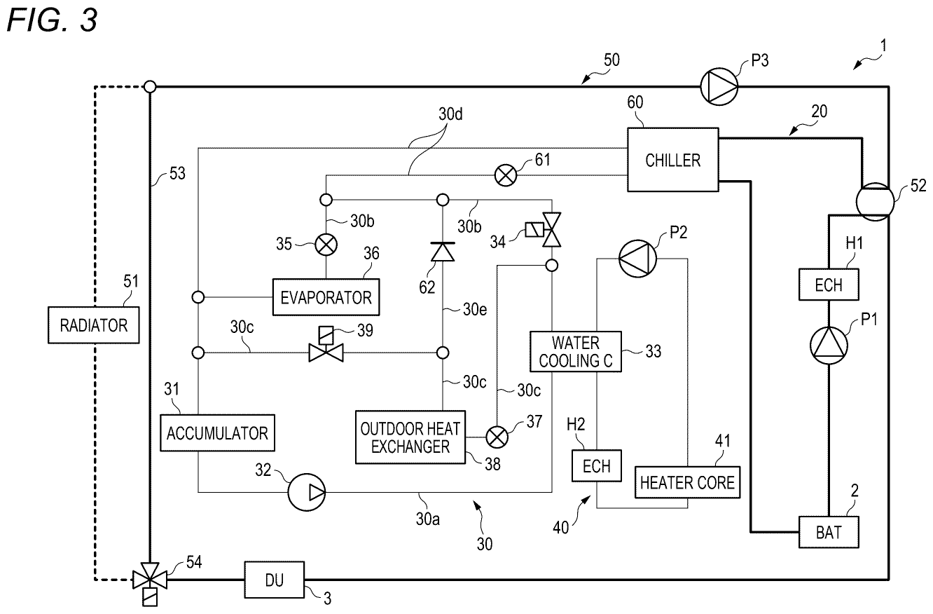

The drive device cooling circuit 50 is communicably connected to the battery cooling circuit 20 via a first switching valve 52. The first switching valve 52 is, for example, a four-way valve, and switches between a communication state (see FIG. 3) in which communication between the drive device cooling circuit 50 and the battery cooling circuit 20 is allowed and a shut-off state (see FIG. 2) in which the communication between the drive device cooling circuit 50 and the battery cooling circuit 20 is shut off.

The drive device cooling circuit 50 includes a bypass flow path 53 bypassing the radiator 51 and a second switching valve 54 disposed at a branch point of the bypass flow path 53. The second switching valve 54 is, for example, a three-way valve, and switches between a bypass state (see FIG. 3) in which the first coolant passes through the bypass flow path 53 and a non-bypass state (see FIG. 2) in which the first coolant passes through the radiator 51.

The chiller 60 is configured to exchange heat between the first coolant flowing through the battery cooling circuit 20 and the second coolant flowing through the refrigeration cycle 30. The first coolant in the battery cooling circuit 20 passes through the inside of the chiller 60 at a downstream side of the first switching valve 52 and an upstream side of the battery 2. The second coolant flowing through the refrigeration cycle 30 passes through the inside of the chiller 60 via a chiller connection flow path 30d connected to the flow path for cooling 30b. The chiller connection flow path 30d is provided with an expansion valve for chiller 61 for the second coolant to absorb heat from the chiller 60.

In the coolant circuit 1 configured as described above, by switching the first switching valve 52, the communication between the drive device cooling circuit 50 and the battery cooling circuit 20 can be allowed or shut off, and the battery 2 can be cooled via the radiator 51 and/or the chiller 60.

By the way, since it is impossible for an electric vehicle to use waste heat of an engine for heating a passenger compartment like an ICE vehicle, the electric power consumption during heating tends to increase and a driving range tends to be shorter, but according to the coolant circuit 1 as described below, the electric power consumption during heating can be reduced.

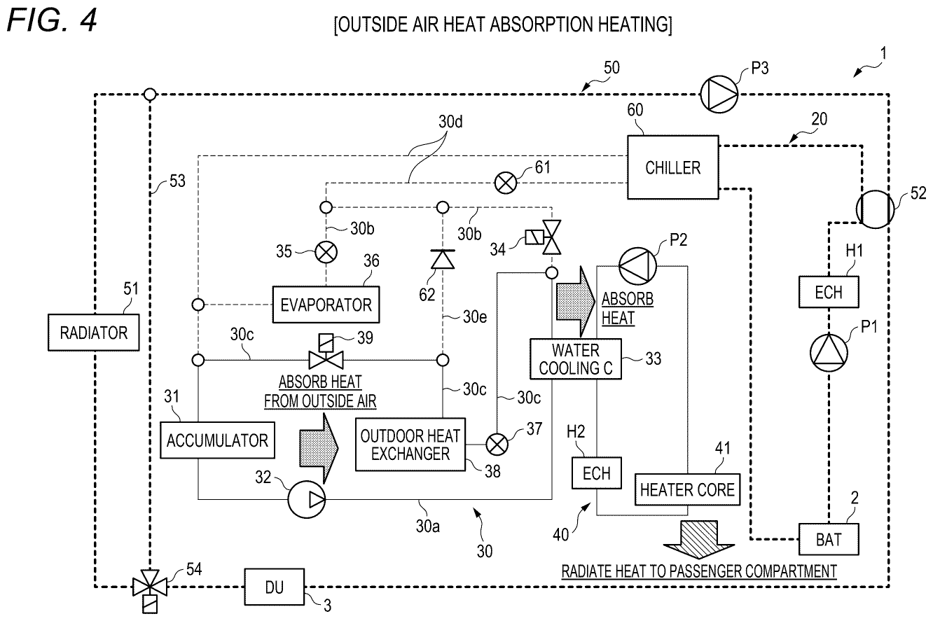

Hereinafter, three passenger compartment heating modes performed by the coolant circuit 1 will be described with reference to FIGS. 4 to 6. In the circuit of FIGS. 4 to 6, only a flow of the coolant in the part related to the heating of the passenger compartment is indicated by a solid line, and the other parts are indicated by dashed lines.

A first passenger compartment heating mode (outside air heat absorption heating) shown in FIG. 4 is a mode in which the refrigeration cycle 30 and the heating circuit 40 cooperate to absorb heat of the outside air and heat the passenger compartment. The first passenger compartment heating mode (outside air heat absorption heating) is selected when a temperature of the battery 2 or the drive device 3 is low. In this mode, the high pressure solenoid valve 34 is closed, and the low pressure solenoid valve 39 is opened to set the refrigeration cycle 30 to a heating operation state.

In this state, the second coolant having a low pressure and a low temperature due to the expansion valve for heating 37 absorbs heat from the outside air by an outdoor heat exchanger 38, is compressed by the electric compressor 32 to have a high pressure and a high temperature, and is sent to the condenser 33. In the condenser 33, a heat exchange is performed between the second coolant flowing through the refrigeration cycle 30 and the third coolant flowing through the heating circuit 40, and the third coolant absorbing heat from the second coolant of the refrigeration cycle 30 flows through the heating circuit 40. Heat of the third coolant is radiated in the passenger compartment from the heater core 41 of the heating circuit 40, and the passenger compartment is heated.

In this way, in the first passenger compartment heating mode (outside air heat absorption heating), since a heating pump of the refrigeration cycle 30 can be used to absorb heat of the outside air, electric power consumption of the second electric heater H2 during heating can be reduced. Accordingly, a driving range of the vehicle V during heating can be extended.

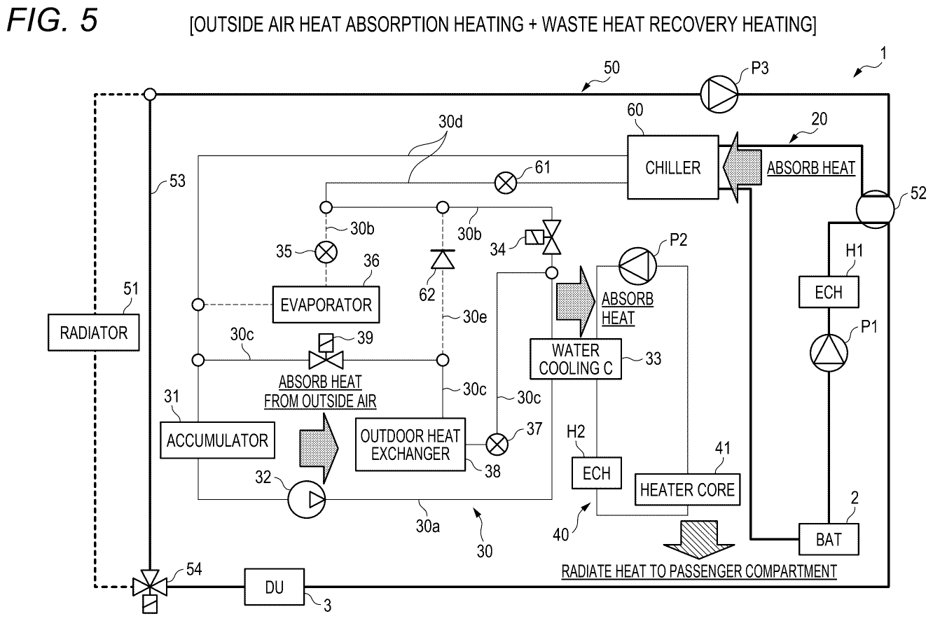

A second passenger compartment heating mode (outside air heat absorption heating+waste heat recovery heating) shown in FIG. 5 is a mode in which the battery cooling circuit 20, the refrigeration cycle 30, the heating circuit 40, the drive device cooling circuit 50, and the chiller 60 cooperate to absorb heat of the outside air and perform waste heat recovery, and the passenger compartment is heated. The second passenger compartment heating mode (outside air heat absorption heating+waste heat recovery heating) is selected when the temperature of the battery 2 or the drive device 3 is high. In this mode, the high pressure solenoid valve 34 and the low pressure solenoid valve 39 are opened to set the refrigeration cycle 30 to the heating operation state, and the refrigeration cycle 30 is connected to the chiller 60 via the chiller connection flow path 30d. The first switching valve 52 is set to the communication state in which the communication between the drive device cooling circuit 50 and the battery cooling circuit 20 is allowed, and the second switching valve 54 is set to the bypass state in which the first coolant passes through the bypass flow path 53.

In this state, the first coolant heated by heat of the battery 2 or the drive device 3 is circulated in the battery cooling circuit 20 and the drive device cooling circuit 50 without being cooled by the radiator 51, and passes through the chiller 60. On the other hand, the second coolant having a low pressure and a low temperature due to the expansion valve for chiller 61 absorbs heat from the first coolant by a heat exchange in the chiller 60. The second coolant having a low pressure and a low temperature due to the expansion valve for heating 37 absorbs heat from the outside air by the outdoor heat exchanger 38. Thereafter, the second coolant is compressed by the electric compressor 32 to have a high pressure and a high temperature, and is sent to the condenser 33. In the condenser 33, the heat exchange is performed between the second coolant flowing through the refrigeration cycle 30 and the third coolant flowing through the heating circuit 40, and the third coolant absorbing heat from the second coolant of the refrigeration cycle 30 flows through the heating circuit 40. Heat of the third coolant is radiated in the passenger compartment from the heater core 41 of the heating circuit 40, and the passenger compartment is heated.

In this way, in the second passenger compartment heating mode (outside air heat absorption heating+waste heat recovery heating), since the heating pump of the refrigeration cycle 30 can be used to absorb heat of the outside air, and waste heat of the battery 2 or the drive device 3 can be absorbed via the chiller 60, the electric power consumption of the second electric heater H2 during heating can be further reduced. Accordingly, the driving range of the vehicle V during heating can be further extended.

The first coolant which is circulated in the battery cooling circuit 20 and the drive device cooling circuit 50 can radiate heat and be cooled by the chiller 60 to cool the battery 2 and the drive device 3.

If a temperature of the third coolant is low for a heating request in the first passenger compartment heating mode (outside air heat absorption heating) and the second passenger compartment heating mode (outside air heat absorption heating+waste heat recovery heating), the heating request can be satisfied by heating with the second electric heater H2.

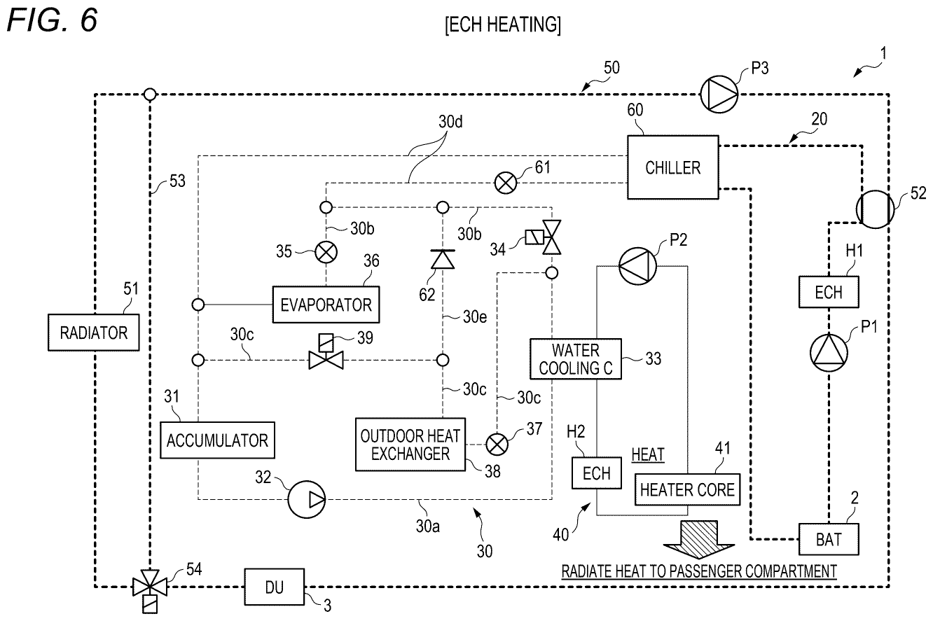

A third passenger compartment heating mode (ECH heating) shown in FIG. 6 is a mode in which the heating circuit 40 heats the passenger compartment alone. The third passenger compartment heating mode (ECH heating) is selected when an outside air temperature is low. In this mode, the electric compressor 32 is stopped because the outside air temperature is low and heat of the outside air cannot be absorbed, and the second electric heater H2 is set to an ON state. In this state, the third coolant flowing through the heating circuit 40 is heated by the second electric heater H2. Heat of the third coolant is radiated in the passenger compartment from the heater core 41 of the heating circuit 40, and the passenger compartment is heated.

In this way, in the third passenger compartment heating mode (ECH heating), even if the outside air temperature is low and an effect of absorbing heat of the outside air cannot be expected, the passenger compartment can be heated by the second electric heater H2.

Although various embodiments have been described above with reference to the drawings, the present invention is not limited to these examples. It is apparent to those skilled in the art that various changes or modifications can be conceived within the scope described in the claims, and it is understood that the changes or modifications naturally fall within the technical scope of the present invention. In addition, respective constituent elements in the above-described embodiments may be freely combined without departing from the gist of the invention.

In the present description, at least the following matters are described. Although corresponding constituent elements or the like in the embodiment described above are shown in parentheses, the present invention is not limited thereto.

(1) A vehicle (vehicle V), including:
a battery (battery 2);
a battery cooling circuit (battery cooling circuit 20) configured to allow a first coolant to flow and adjust a temperature of the battery;
a refrigeration cycle for air conditioning (refrigeration cycle 30) including an electric compressor (electric compressor 32), a condenser (condenser 33), an outdoor heat exchanger (outdoor heat exchanger 38), and an evaporator (evaporator 36), and configured to allow a second coolant to flow; and
a heating circuit (heating circuit 40) including a heater core (heater core 41) and configured to allow a third coolant to flow, in which
the battery cooling circuit, the refrigeration cycle, and the heating circuit are configured to allow the first coolant, the second coolant, and the third coolant to flow through respective circuits independently, and
the condenser is configured to exchange heat between the second coolant flowing through the refrigeration cycle and the third coolant flowing through the heating circuit.

According to (1), the coolants flowing through the battery cooling circuit for the battery, the refrigeration cycle for cooling, and the heating circuit for heating are independent, and thus cooling and heating in the passenger compartment can be performed without being affected by the battery cooling circuit, and comfort of the vehicle is improved. An HVAC is mounted in an engine vehicle in the related art, but the battery cooling circuit is independent of the refrigeration cycle and the heating circuit, and thus it is possible to continue to use the HVAC of the engine vehicle at a low cost.

(2) The vehicle according to (1), in which
in the refrigeration cycle, the condenser is provided at a downstream of the electric compressor.

According to (2), heat of the second coolant having a high temperature and a high pressure compressed by the electric compressor can be supplied to the heating circuit via the condenser.

(3) The vehicle according to (2), in which
the heating circuit includes an electric heater (second electric heater H2).

According to (3), if heat of the second coolant supplied from the refrigeration cycle cannot perform sufficient heating, heating can be performed by using heat of the electric heater provided in the heating circuit.

(4) The vehicle according to any one of (1) to (3), further including:
a chiller (chiller 60) configured to exchange heat between the first coolant flowing through the battery cooling circuit and the second coolant flowing through the refrigeration cycle.

According to (4), the battery can be cooled by radiating heat of the first coolant flowing through the battery cooling circuit to the second coolant via the chiller.

(5) The vehicle according to (4), further including:
a drive device (drive device 3);
a drive device cooling circuit (drive device cooling circuit 50) configured to allow the first coolant to flow and cool the drive device; and
a first switching valve (first switching valve 52) configured to switch between a communication state in which the drive device cooling circuit and the battery cooling circuit communicate with each other and a shut-off state in which communication between the drive device cooling circuit and the battery cooling circuit is shut off.

According to (5), by setting the first switching valve to the communication state, waste heat of the drive device can heat the battery or can be used to heat the passenger compartment.

(6) The vehicle according to (5), in which
the drive device cooling circuit includes:
   a radiator (radiator 51);
   a bypass flow path (bypass flow path 53) bypassing the radiator; and
   a second switching valve (second switching valve 54) configured to switch between a bypass state in which the drive device cooling circuit is configured to allow the first coolant to flow through the bypass flow path and a non-bypass state in which the drive device cooling circuit is configured to allow the first coolant to flow through the radiator.

According to (6), by setting the second switching valve to the bypass state, waste heat of the drive device can be used without being radiated to the outside of the vehicle.

(7) The vehicle according to (6), being configured to
set the first switching valve to the communication state, and set the second switching valve to the bypass state, and
heat the third coolant by absorbing heat from the first coolant via the chiller and absorbing heat from the second coolant via the condenser, thereby using heat of the drive device to heat a passenger compartment.

According to (7), by using waste heat of the drive device to heat the passenger compartment, electric power consumption of the electric compressor can be reduced.

What is claimed is:

1. A vehicle, comprising:
a battery;
a battery cooling circuit configured to allow a first coolant to flow and adjust a temperature of the battery;
a refrigeration cycle for air conditioning including an electric compressor, a condenser, an outdoor heat exchanger, and an evaporator, and configured to allow a second coolant to flow; and
a heating circuit including a heater core and configured to allow a third coolant to flow, wherein
the battery cooling circuit, the refrigeration cycle, and the heating circuit are configured to allow the first coolant, the second coolant, and the third coolant flow through respective circuits independently, and
the condenser is configured to exchange heat between the second coolant flowing through the refrigeration cycle and the third coolant flowing through the heating circuit.

2. The vehicle according to claim 1, wherein
in the refrigeration cycle, the condenser is provided at a downstream of the electric compressor.

3. The vehicle according to claim 2, wherein
the heating circuit includes an electric heater.

4. The vehicle according to claim 1, further comprising:
a chiller configured to exchange heat between the first coolant flowing through the battery cooling circuit and the second coolant flowing through the refrigeration cycle.

5. The vehicle according to claim 4, further comprising:
a drive device;
a drive device cooling circuit configured to allow the first coolant to flow and cool the drive device; and
a first switching valve configured to switch between a communication state in which the drive device cooling circuit and the battery cooling circuit communicate with each other and a shut-off state in which communication between the drive device cooling circuit and the battery cooling circuit is shut off.

6. The vehicle according to claim 5, wherein
the drive device cooling circuit includes:
a radiator;
a bypass flow path bypassing the radiator; and
a second switching valve configured to switch between a bypass state in which the drive device cooling circuit is configured to allow the first coolant to flow through the bypass flow path and a non-bypass state in which the drive device cooling circuit is configured to allow the first coolant to flow through the radiator.

7. The vehicle according to claim 6, being configured to
set the first switching valve to the communication state, and set the second switching valve to the bypass state, and
heat the third coolant by absorbing heat from the first coolant via the chiller and absorbing heat from the second coolant via the condenser, thereby using heat of the drive device to heat a passenger compartment.
